(19) United States
(12) Patent Application Publication
(10) Pub. No.: US 2022/0089904 A1
(43) Pub. Date: Mar. 24, 2022

(54) Coating Compositions Containing Odor Control Agents and Methods of Forming Coatings Therefrom

(71) Applicant: PPG Industries Ohio, Inc., Cleveland, OH (US)

(72) Inventors: Matteo Bertoli, Casnate con Bernate (IT); Michela Cagliani, Paderno Dugnano (IT); Maurizio Ballarino, Milano (IT); Christian Dagostino, Cormano (IT); Renato Liano, Olgiate Olona (IT); Alessio Stellini, Sedriano (IT)

(73) Assignee: PPG Industries Ohio, Inc., Cleveland, OH (US)

(21) Appl. No.: 17/420,001

(22) PCT Filed: Dec. 27, 2019
(86) PCT No.: PCT/US2019/068739

§ 371 Date: Jun. 30, 2021

(30) Foreign Application Priority Data
Dec. 27, 2018 (IT) 102018000021058

(51) Int. Cl. C09D 181/02; C08G 75/04; C08K 5/544; C09D 7/63; C09D 7/20; C09D 5/00

(52) U.S. Cl. CPC C09D 181/02; C08G 75/04; C09D 5/002; C09D 7/63; C09D 7/20; C08K 5/544

(57) ABSTRACT

A coating composition includes: (a) (i) a thiol functional compound and (ii) an ethylenically unsaturated compound reactive with (i); (b) a catalyst that catalyzes a reaction between (i) and (ii); and (c) an odor masking agent that masks an odor of at least (i) the thiol functional compound. A method of forming the coating is also included.

### FIELD OF THE INVENTION

The present invention relates to coating compositions containing odor control agents and methods of forming coatings from such coating compositions.

### BACKGROUND OF THE INVENTION

Coatings formed from compositions containing thiol functional compounds provide various benefits including fast on-demand cure, good coating appearance, and other desirable properties. Coatings formed from compositions containing thiol functional compounds also provide an alternative to other types of coatings such as coatings formed from isocyanate functional compounds. While compositions containing thiol functional compounds provide numerous benefits, these compositions typically have an unpleasant smell. Because of their strong unpleasant smell, thiol containing compositions are frequently avoided. It is, therefore, desirable to provide thiol based coating compositions that have a pleasant smell and which form coatings having good appearance and other desirable properties.

### SUMMARY OF THE INVENTION

The present invention relates to a coating composition comprising: (a) (i) a thiol functional compound and (ii) an ethylenically unsaturated compound reactive with (i); (b) a catalyst that catalyzes a reaction between (i) and (ii); and (c) an odor masking agent that masks an odor of at least (i) the thiol functional compound.

The present invention also relates to a substrate coated with a coating formed from the above coating composition.

The present invention further relates to a method of forming a coating over at least a portion of a substrate comprising: (1) applying a coating composition to at least a portion of a substrate, the coating composition comprising: (a) (i) a thiol functional compound and (ii) an ethylenically unsaturated compound reactive with (i); (b) a catalyst that catalyzes a reaction between (i) and (ii); and (c) an odor masking agent that masks an odor of at least (i) the thiol functional compound; and (2) curing the coating composition to form a coating.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “a” coating composition, and the like refer to one or more of any of these items.

The present invention relates to a coating composition comprising: (a) (i) a thiol functional compound and (ii) an ethylenically unsaturated compound reactive with (i); (b) a catalyst that catalyzes a reaction between (i) and (ii); and (c) an odor masking agent that masks an odor of at least (i) the thiol functional compound.

The thiol functional compound can comprise a linear, branched, or cyclic structure that has thiol functional groups. The term “linear” refers to a compound having a straight hydrocarbon chain, the term “branched” refers to a compound having a hydrocarbon chain with a hydrogen replaced by a substituent such as an alkyl group that branches or extends out from a straight chain, and the term “cyclic” refers to a closed ring structure. The cyclic structures can include aliphatic cyclic structures or aromatic cyclic structures. As used herein, an “aromatic group” refers to a cyclically conjugated hydrocarbon with a stability (due to delocalization) that is significantly greater than that of a hypothetical localized structure. Further, the term “aliphatic” refers to non-aromatic structures that contain saturated carbon bonds. The cyclic structures also encompass bridged ring polycycloalkyl groups (or bridged ring polycyclic groups) and fused ring polycycloalkyl groups (or fused ring polycyclic groups).

Further, the linear, branched, or cyclic structures can comprise an interrupting heteroatom, functional group, or combination thereof. The interrupting heteroatom and functional group can include but are not limited to: (i) a heteroatom including, but not limited to, an oxygen atom, a nitrogen atom, a sulfur atom, or a combination thereof and/or (ii) a functional group including, but not limited to, an ester group, an ether group, a carbonyl group, an amide group, an amino group, or combinations thereof. For example, the thiol functional compound can comprise a branched hydrocarbon structure comprising ester linkages and thiol functional groups.

The thiol functional compound used with the present invention can comprise at least 2 or at least 3 thiol functional groups. The thiol functional compound can comprise up to 6 thiol functional groups, up to 5 thiol functional groups, or up to 4 thiol functional groups. The thiol functional compound can also comprise a number of thiol functional groups within a range such as, for example, of from 2 to 6 thiol functional groups, or from 3 to 5 thiol functional groups.

Non-limiting examples of thiol functional compounds that can be used with the present invention include trimethylolpropane tri s(3-mercaptopropionate), trimethyloipropane trimercaptoacetate, pentaerythritol tetra(3-mercaptopropionate), pentaerythritol tetramercaptoacetate, glycol dimercaptoacetate, glycol di(3-mercaptopropionate), ethoxylated trimethylolpropane tri-3-mercaptopropionate, polypropylene glycol (3-mercaptopropionate), and combinations thereof. Commercially available thiol functional compounds that can be used with the present invention include the compounds commercially available from Evans Chemetics LP under the trade name THIOCURE.

The thiol functional compound can also comprise additional functional groups. For example, the thiol functional compound can also comprise carboxylic acid groups, keto functional groups (also referred to as ketone functional groups), aldo functional groups (also referred to as aldehyde functional groups), amine groups, hydroxyl groups, carbamate groups, amide groups, urea groups, isocyanate groups (including blocked isocyanate groups), ethylenically unsaturated groups, and combinations thereof. Alternatively, the thiol functional compound can also be free of (i.e., does not contain) any one or all of the previously described additional functional groups such as, for example, isocyanate groups (including blocked isocyanate groups). The thiol functional compound can also be free of silane groups (for example free of alkoxysilane groups) such that the thiol functional compound is a non-silane or non-alkoxysilane compound comprising thiol functional groups.

The thiol functional compounds can comprise at least 5 weight %, at least 8 weight %, at least 10 weight %, or at least 12 weight %, based on the total weight of the coating composition. The thiol functional compounds can comprise up to 40 weight %, up to 30 weight %, up to 25 weight %, or up to 20 weight %, based on the total weight of the coating composition. The thiol functional compounds can also comprise an amount within a range such as from 5 weight % to 40 weight %, or from 8 weight % to 30 weight %, or from 10 weight % to 25 weight %, or from 12 weight % to 20 weight %, based on the total weight of the coating composition.

As indicated, the coating composition of the present invention also comprises an ethylenically unsaturated functional compound reactive with the thiol functional compound. It is appreciated that the ethylenically unsaturated groups of the ethylenically functional compound can react with the thiol functional groups of the thiol functional compound through a thiol-ene reaction of a Michael addition pathway. The reaction between the two compounds allow for the formation of a resinous film coated over at least a portion of a substrate as further described herein.

As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof. The term “(meth)acrylate” refers to both the methacrylate and the acrylate.

The ethylenically unsaturated functional compound can comprise a linear, branched, or cyclic structure that has ethylenically unsaturated functional groups. Further, the linear, branched, or cyclic structures can comprise an interrupting heteroatom, functional group, or combination thereof. The interrupting heteroatoms and functional groups can include, but are not limited to, any of the heteroatoms and functional groups previously described.

The ethylenically unsaturated functional compound used with the present invention can comprise at least 2 or at least 3 ethylenically unsaturated functional groups. The ethylenically unsaturated functional compound can comprise up to 6 ethylenically unsaturated functional groups, up to 5 ethylenically unsaturated functional groups, or up to 4 ethylenically unsaturated functional groups. The ethylenically unsaturated functional compound can also comprise a number of ethylenically unsaturated functional groups within a range such as, for example, of from 2 to 6 ethylenically unsaturated functional groups, or from 3 to 5 ethylenically unsaturated functional groups.

The amount of ethylenically unsaturated groups on the ethylenically unsaturated functional compound can also be selected based on the amount of thiol functional groups on the thiol functional compound. For instance, the ethylenically unsaturated functional compound and the thiol functional group can be selected such that the ratio of ethylenically unsaturated functional groups to thiol functional groups is within a range of from 0.5:1 to 1:0.5, or from 0.8:1 to 1:0.8.

Non-limiting examples of ethylenically unsaturated functional compounds that can be used with the present invention include dipentaerythritol pentaacrylate, trimethylolpropane trimethacrylate, di-trimethylolpropane tetraacrylate, tris (2-hydroxy ethyl) isocyanurate triacrylate, ethoxylated trimethylolpropane triacrylate, pentaerythritol tetraacrylate, or any combination thereof. Commercially available ethylenically unsaturated functional compounds that can be used with the present invention include compounds commercially available from Sartomer (Arkema Group).

The ethylenically unsaturated functional compound can also comprise additional functional groups including, but not limited to, any of the additional functional groups previously described. Alternatively, the ethylenically unsaturated functional compound can also be free of (i.e., does not contain) any one or all of the previously described additional functional groups such as isocyanate functional groups for example. The ethylenically unsaturated functional compound can also be free of silane groups (for example free of alkoxysilane groups) such that the ethylenically unsaturated functional compound is a non-silane or non-alkoxysilane compound comprising ethylenically unsaturated functional groups.

The ethylenically unsaturated functional compounds can comprise at least at least 5 weight %, at least 10 weight %, at least 15 weight %, or at least 20 weight %, based on the total weight of the coating composition. The ethylenically unsaturated functional compounds can comprise up to 40 weight %, up to 35 weight %, up to 30 weight %, or up to 25 weight %, based on the total weight of the coating composition. The ethylenically unsaturated functional compounds can also comprise an amount within a range such as from 5 weight % to 40 weight %, or from 10 weight % to 35 weight %, or from 15 weight % to 30 weight %, or from 20 weight % to 30 weight %, based on the total weight of the coating composition.

The thiol functional compounds and ethylenically unsaturated functional compounds can each independently comprise monomers and/or polymers that contain the respective thiol and ethylenically unsaturated functional groups. As used herein, the term “polymer” refers to oligomers and homopolymers (e.g., prepared from a single monomer species), copolymers (e.g., prepared from at least two monomer species), terpolymers (e.g., prepared from at least three monomer species) and graft polymers. The term “resin” is used interchangeably with “polymer.”

It is appreciated that the coating composition can comprise a film-forming binder that comprises the thiol functional compound and the ethylenically unsaturated compound reactive with the thiol functional compound. As used herein, a “film-forming binder” refers to a main constituent material that forms a film and holds all components together upon curing of the coating composition. The reaction between the thiol functional compound and the ethylenically unsaturated compound forms a resinous film of the binder. A “resinous film” refers to a resin that forms a self-supporting continuous film on at least a horizontal surface of a substrate upon removal of any diluents or carriers present in the composition and/or upon curing.

As previously described, the coating composition of the present invention further comprises a catalyst that catalyzes a reaction between the thiol functional compounds and ethylenically unsaturated functional compounds. As used herein, a “catalyst” refers to a substance that increases the rate of reaction between reactive components. Non-limiting examples of catalysts that can be used with the present invention include bases, metals, organometallics, Lewis acids, nucleophiles, or any combination thereof. For example, the catalyst can be selected from an amine compound including, but not limited to, primary amines, secondary amines, and tertiary amines. For example, the catalyst can comprise a tertiary amine including, but not limited to, triethylamine, dimethylethanolamine, 1,4-diazabicyclo[2.2.2]octane (a bis-tertiary amine), or any combination thereof.

The catalyst used with the present invention can be selected from a Michael addition catalyst that catalyzes a Michael addition reaction between the thiol functional compounds and ethylenically unsaturated functional compounds. As used herein, a “Michael addition catalyst” refers to a substance that increases the rate of reaction between reactive components in a Michael addition reaction. The Michael addition catalyst is, therefore, selected to increase the rate of a Michael addition reaction between the thiol functional compounds and ethylenically unsaturated functional compounds. The Michael addition catalyst can comprise any of the previously described catalysts and which catalyze a Michael addition reaction between the thiol functional compounds and ethylenically unsaturated functional compounds. For example, the Michael addition catalyst can comprise an amine catalyst including, but not limited to, any of the previously described amine catalysts that catalyze a Michael addition reaction (e.g., a tertiary amine such as triethylamine).

The coating compositions can also be free of different types of catalysts other than Michael addition catalysts. For example, the coating composition can be substantially free, essentially free, or completely free of different types of catalysts other than the Michael addition catalysts. The terms “substantially free of different types of catalysts other than the Michael addition catalysts” means that the composition contains less than 1000 parts per million (ppm) of different types of catalysts other than the Michael addition catalysts, “essentially free of different types of catalysts other than the Michael addition catalysts” means that the composition contains less than 100 ppm of different types of catalysts other than the Michael addition catalysts, and “completely free of different types of catalysts other than the Michael addition catalysts” means that the composition contains less than 20 parts per billion (ppb) of different types of catalysts other than the Michael addition catalysts.

In accordance with the present invention, the coating composition further comprises an odor masking agent that masks an odor of at least the thiol functional compound. The odor masking agent provides a more pleasing scent, such as a vanilla or strawberry smell for instance, that masks the unpleasant smell of at least the thiol functional compound. The odor masking agents can be selected from one or more flavor agents or other compounds that provide a known scent. The odor masking agent can also be selected from one or more compounds that have a higher vapor pressure and/or vapor density than the thiol functional compounds.

The odor masking agent used with the present invention can comprise at least one aromatic compound. Non-limiting examples of suitable odor masking agents include compounds known to provide a desired scent and which comprise aromatic groups including six-membered or five-membered aromatic rings (e.g., furans). Specific non-limiting examples of an odor masking agent includes vanillin and its derivatives such as ethyl vanillin, cinnamaldehydes (also referred to as cinnamals) and its derivatives such as hexyl cinnamaldehyde, benzaldehyde, benzyl acetate, ethyl methylphenylglycidate, methyl anthranilate, and combination thereof. The odor masking agent can also include additional non-aromatic compounds (in addition to the aromatic compounds) including, but not limited to, non-aromatic esters, ethers, aldehydes, lactones, or any combination thereof. For example, the odor masking agent can comprise at least one aromatic compound (such as any of the aromatic compounds previously described) and at least one non-aromatic compound such as, for example, isoamyl acetate (also referred to as 3-methylbutyl acetate), pentyl butyrate, 4-hydroxy-2,5-dimethyl-3(2H)-furanone (also referred to as furaneol), allyl hexanoate, diacetyl, gamma-undecalactone, vertocitral, or any combination thereof. Commercially available odor masking agents that can be used with the present invention include the compounds commercially available from Synthron under the trade name MASQUODOR, such as MASQUODOR FR and MASQUODOR VN for example.

The odor masking agents can be added to the compositions of the present invention in an amount to provide the desired smell or odor masking effect. For example, the odor masking agents can comprise at least 0.001 weight %, at least 0.01 weight %, at least 0.1 weight %, at least 1 weight %, at least 5 weight %, or at least 10 weight %, based on the total weight of the coating composition. The odor masking agents can comprise up to 50 weight %, up to 40 weight %, up to 30 weight %, up to 20 weight %, or up to 15 weight %, based on the total weight of the coating composition. The odor masking agents can comprise an amount within a range such as, for example, of from 0.001 weight % to 50 weight %, or from 0.01 weight % to 40 weight %, or from 0.01 weight % to 30 weight %, or from 1 weight % to 20 weight %, or from 0.01 weight % to 10 weight %, or from 1 weight % to 10 weight %, based on the total weight of the coating composition.

The coating composition can also include additional components. For example, the coating composition can further include an adhesion promoter and/or a surface conditioner. As used herein, an “adhesion promoter” refers to a component or group of components, such as monomers or polymers for example, that increase the adhesion of a coating layer to a substrate. The adhesion promoter can be incorporated into the present invention and/or the adhesion promoter can be applied to a substrate before applying the coating composition as described in further detail herein.

The adhesion promoter can be selected from components that react with the surface of the substrate and a component of the coating composition, such as the thiol functional compounds and/or ethylenically unsaturated functional compounds of the binder system. Non-limiting examples of adhesion promoters that can be used with the present invention include epoxy, thiol and/or ethylenically unsaturated functional alkoxysilanes such as 3-methacryloxypropyltrimethoxysilane, 3-glycidyloxypropyltrimethoxysilane vinyltrimethoxysilane, vinyltriethoxysilane, 3-mercaptopropyltriethoxysilane, and any combination thereof. Commercially available alkoxysilanes include those commercially available from Evonik Industries under the trade name DYNASYLAN.

It is appreciated that the adhesion promtoer can form a portion of the film-forming binder such as by reacting with the thiol and/or ethylenically unsaturated functional compounds that also form a portion of the film-forming binder. It is also appreciated that the adhesion promoter is different from the previously described thiol and ethylenically unsaturated functional compounds. For example, the adhesion promoter can be an alkoxysilane with one or more of the previously described functional groups, while the thiol and ethylenically unsaturated functional compounds are not an alkoxysilane compound (i.e. non-alkoxysilane compounds comprising thiol or ethylenically unsaturated functional compounds).

As indicated, the coating composition can also include a surface conditioner. As used herein, a “surface conditioner” refers to a component or group of components, such as monomers or polymers for example, that change the surface property of the substrate in order to obtain different effects. For instance, the surface conditioner can be selected to increase the curing speed and/or the affinity and/or the passivation of the substrate surface. The surface conditioner can be incorporated into the present invention and/or the surface conditioner can be applied to a substrate before applying the coating composition as described in further detail herein.

Non-limiting examples of surface conditioners that can be used with the present invention include halogen containing silanes and/or amino functional silanes (e.g. amino functional alkoxysilanes and/or amino functional siloxanes). It is appreciated that the silanes can comprise one or multiple halogen and/or amino groups such as one, two, three, or more halogen and/or amino functional groups. Specific non-limiting examples of surface conditioners include tert-butyltrichlorosilane, aminopropyltriethoxysilane, diamino functional oligomeric siloxane, and combinations thereof. Commercially available silanes include those commercially available from Momentive Performance Materials under the trade name SILQUEST, and from Evonik Industries under the trade name DYNASYLAN.

The coating composition can also comprise additional film-forming resins. The additional resins can include any of a variety of thermoplastic and/or thermosetting resins known in the art. As used herein, the term “thermosetting” refers to resins that “set” irreversibly upon curing or crosslinking, wherein the polymer chains are joined together by covalent bonds. This property is usually associated with a cross-linking reaction often induced, for example, by heat or radiation. Curing or crosslinking reactions also may be carried out under ambient conditions. Once cured, a thermosetting resin will not melt upon the application of heat and is insoluble in solvents. As noted, the additional resins can also include a thermoplastic resin. As used herein, the term “thermoplastic” refers to resins that include polymeric components that are not joined by covalent bonds and, thereby, can undergo liquid flow upon heating.

The additional resins can be selected from, for example, polyurethanes, polyester polymers, polyamide polymers, polyether polymers, polysiloxane polymers, epoxy resins, vinyl resins, (meth)acrylate polymers, copolymers thereof, and mixtures thereof. Thermosetting resins typically comprise reactive functional groups. The reactive functional groups can include, but are not limited to, carboxylic acid groups, amine groups, epoxide groups, alkoxy groups, hydroxyl groups, thiol groups, carbamate groups, amide groups, urea groups, isocyanate groups (including blocked isocyanate groups), and combinations thereof.

Coating compositions containing thermosetting resins are typically reacted with a crosslinker. As such, when additional film-forming resins are used in the coating composition, the coating composition can comprise crosslinkers that are reactive with the additional film-forming resins and/or the crosslinker reactive with the polymer reaction product can also be reactive with the additional film-forming resin. Non-limiting examples of such crosslinkers include any of the crosslinkers known in the art to react with the functionality of the resins used in the coating compositions. The thermosetting resins can also have functional groups that are reactive with themselves; in this manner, such resins are self-crosslinking.

As used herein, the term “crosslinker” refers to a molecule comprising two or more functional groups that are reactive with other functional groups and which is capable of linking two or more monomers or polymer molecules through chemical bonds such as during a curing process. The terms “curable”, “cure”, and the like, as used in connection with a coating composition, mean that at least a portion of the components that make up the coating composition are polymerizable and/or crosslinkable. The coating composition of the present invention can be cured at ambient conditions, with heat, or with other means such as actinic radiation. The term “actinic radiation” refers to electromagnetic radiation that can initiate chemical reactions. Actinic radiation includes, but is not limited to, visible light, ultraviolet (UV) light, X-ray, infrared (IR), and gamma radiation. Further, “ambient conditions” refers to the conditions of the surrounding environment (e.g., the temperature, humidity, and pressure of the room or outdoor environment in which the substrate is located).

It is appreciated that when additional film-forming resins and/or crosslinkers are used in the coating composition, the additional film-forming resins and/or crosslinkers can form a portion of the film-forming binder of the coating composition.

The coating composition can also be free of any of the additional film-forming resins and/or crosslinkers. For example, the coating composition can be substantially free, essentially free, or completely free of additional film-forming resins and/or crosslinkers such as, for example, isocyanate functional compounds. The terms “substantially free of isocyanate functional compounds” means that the composition contains less than 1000 parts per million (ppm) of isocyanate functional compounds, “essentially free of isocyanate functional compounds” means that the composition contains less than 100 ppm of isocyanate functional compounds, and “completely free of isocyanate functional compounds” means that the composition contains less than 20 parts per billion (ppb) of isocyanate functional compounds.

The coating compositions can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present invention.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

Example dyes include, but are not limited to, those that are solvent and/or aqueous based such as phthalo green or blue, iron oxide, bismuth vanadate, anthraquinone, and perylene and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions Division of Eastman Chemical, Inc.

Other non-limiting examples of components that can be used with the coating compositions of the present invention include plasticizers, abrasion resistant particles, fillers including, but not limited to, micas, talc, clays, and inorganic minerals, anti-oxidants, hindered amine light stabilizers, UV light absorbers and stabilizers, surfactants, flow and surface control agents, thixotropic agents, organic cosolvents, reactive diluents, reaction inhibitors, corrosion-inhibitors, and other customary auxiliaries.

The components that form the coating composition can be combined and mixed in a liquid medium prior to applying the coating composition to a substrate to form a coating. For example, the components can be combined and mixed in a non-aqueous medium or an aqueous medium. The term “non-aqueous” refers to a liquid medium comprising less than 50 weight % water, based on the total weight of the liquid medium. In accordance with the present invention, such non-aqueous liquid mediums can comprise less than 40 weight % water, or less than 30 weight % water, or less than 20 weight % water, or less than 10 weight % water, or less than 5% water, based on the total weight of the liquid medium. The solvents that make up more than 50 weight % of the liquid medium include organic solvents. Non-limiting examples of suitable organic solvents include polar organic solvents (e.g. protic organic solvents such as glycols, glycol ether alcohols, alcohols; and ketones, glycol diethers, esters, and diesters). Other non-limiting examples of organic solvents include aromatic and aliphatic hydrocarbons.

Further, the term “aqueous” refers to a liquid medium comprising more than 50 weight % water, based on the total weight of the liquid medium. In accordance with the present invention, such aqueous liquid mediums can comprise more than 60 weight % water, or more than 70 weight % water, or more than 80 weight % water, or more than 90 weight % water, or more than 95 weight % water, or 100 weight % water, based on the total weight of the liquid medium. The solvents that make up the remaining weight % of the liquid medium include any of the previously described organic solvents.

One or more of the components that form the coating composition can also be stored separately, such as in separate non-aqueous liquid mediums or aqueous liquid mediums, prior to mixing the components together to form the coating composition. For example, the ethylenically unsaturated compound can be stored in a first non-aqueous liquid medium, while the thiol functional compound can be stored in a second non-aqueous liquid medium and the catalyst can be stored in a third non-aqueous liquid medium. Further, the odor masking agent can also be stored in the second non-aqueous liquid medium with the thiol functional compound to mask the smell of the thiol functional compound throughout storage of the components as well as during the final mixing and application of the coating composition. The adhesion promoter and/or surface conditioner can also be stored in a separate aqueous or non-aqueous liquid medium. It is appreciated that each of the liquid mediums can also include other optional additives and components.

The storage of the separate components has been found to provide various benefits. For instance, it was found that storing the thiol functional compound and odor masking agent separately from the catalyst allowed the odor masking agent to mask the unpleasant smell of the thiol functional compound continually over time. That is, when storing the catalyst, thiol functional compound, and odor masking agent in the same liquid medium, the effectiveness of the odor masking agent can fade over time allowing one to smell the unpleasant sent of the thiol functional compound.

After mixing at least some of the previously described components to form the coating composition of the present invention, the composition can be applied to a wide range of substrates known in the coatings industry. For example, the coating composition of the present invention can be applied to automotive substrates (e.g. automotive vehicles including but not limited to cars, buses, trucks, trailers, etc.), industrial substrates, aircraft and aircraft components, marine substrates and components such as ships, vessels, and on-shore and off-shore installations, storage tanks, windmills, nuclear plants, packaging substrates, wood flooring and furniture, apparel, electronics, including housings and circuit boards, glass and transparencies, sports equipment, including golf balls, stadiums, buildings, bridges, and the like. These substrates can be, for example, metallic or non-metallic.

Metallic substrates include, but are not limited to, tin, steel (including electrogalvanized steel, cold rolled steel, hot-dipped galvanized steel, steel alloys, or blasted/profiled steel, among others), aluminum, aluminum alloys, zinc-aluminum alloys, steel coated with a zinc-aluminum alloy, and aluminum plated steel. As used herein, blasted or profiled steel refers to steel that has been subjected to abrasive blasting and which involves mechanical cleaning by continuously impacting the steel substrate with abrasive particles at high velocities using compressed air or by centrifugal impellers. The abrasives are typically recycled/reused materials and the process can efficiently remove mill scale and rust. The standard grades of cleanliness for abrasive blast cleaning is conducted in accordance with BS EN ISO 8501-1.

Further, non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethylene terephthalate) (PET), polycarbonate, polycarbonate acrylobutadiene styrene (PC/ABS), polyamide, plastic composite substrates such as glass or carbon fiber composites, wood, veneer, wood composite, particle board, medium density fiberboard, cement, stone, glass, paper, cardboard, textiles, leather both synthetic and natural, and the like.

The coating compositions of the present invention can be applied by any means standard in the art, such as electrocoating, spraying, electrostatic spraying, dipping, rolling, brushing, and the like. The coatings formed from the coating compositions of the present invention can be applied to a dry film thickness of 30 to 1000 microns, 40 to 300 microns, or 60 to 200 microns.

The coating composition can be applied to a substrate to form a monocoat. As used herein, a “monocoat” refers to a single layer coating system that is free of additional coating layers. Thus, the coating composition comprising the corrosion inhibitor can be applied directly to a substrate without any intermediate coating layer and cured to form a single layer coating, i.e. a monocoat. The coating composition can also be applied directly over a pretreated substrate as a monocoat such as over a substrate treated with the adhesion promoter and/or surface conditioner. It is appreciated that the coating composition can be applied directly over a substrate that is not pretreated such as a substrate that is not pretreated with the adhesion promoter and/or surface conditioner.

Alternatively, the coating composition can be applied to a substrate as a first coating layer along with additional coating layers, such as a second coating layer, to form a multi-layer coating system. It is appreciated that the multi-layer coating can comprise multiple coating layers such as three or more, or four or more, or five or more, coating layers. For example, the previously described coating composition of the present invention can be applied to a substrate as a primer and second and third coating layers, and optionally, additional coatings layers, can be applied over the primer layer as basecoats and/or topcoats. As used herein, a “primer” refers to a coating composition from which an undercoating may be deposited onto a substrate in order to prepare the surface for application of a protective or decorative coating system. A “basecoat” refers to a coating composition from which a coating is deposited onto a primer and/or directly onto a substrate, optionally, including components (such as pigments) that impact the color and/or provide other visual impact, and which may be overcoated with a protective and decorative topcoat.

The additional coating layers, such as a second and third coating layer, can be formed from a coating composition that includes a film-forming resin that is the same or different from the first coating layer. The additional coating layers can be prepared with any of the film-forming resins, crosslinkers, colorants, and/or other components previously described. Further, each coating composition can be applied as a dry-on-dry process where each coating composition is dried or cured to form a coating layer prior to application of another composition coating. Alternatively, all or certain combinations of each coating composition described herein can be applied as a wet-on-wet process and dried or cured together.

The present invention is also directed to a method of forming a coating over at least a portion of a substrate. The method includes applying the previously described coating composition to at least a portion of a substrate and curing the coating composition, such as with heat, for example, to form a coating. As previously described, the components that form the coating composition can be stored in separate liquid mediums. As such, the method can further include storing the components in separate liquid mediums and mixing the separate liquid mediums to form the coating composition before applying the coating composition to the substrate.

The coating formed can also be formed in a single application of the coating composition of the present invention rather than multiple applications of the coating compositions. The coating formed from the single application of the coating composition can further have a high dry film thickness as previously described such as at least 100 microns. Further, the coating can be formed without flashing off before the final cure.

The coatings formed from the previously described coating compositions were found to provide good sag resistance, sanding properties, and final appearance while not exhibiting ringing or mapping. Moreover, the coating composition of the present invention is also easy and pleasant to work with by masking the odor of at least the thiol functional compound. In addition, the coatings can also have a volatile organic content of less than 850 g/l, or less than 750 g/l, or less than 650 g/l, or less than 550 g/l.

The present invention is also directed to the following aspects.

A first aspect is directed to a coating composition comprising: (a) (i) a thiol functional compound; (ii) an ethylenically unsaturated compound reactive with (i); (b) a catalyst that catalyzes a reaction of (i) and (ii); and (c) an odor masking agent that masks an odor of at least (i) the thiol functional compound.

A second aspect is directed to the coating composition of the first aspect comprising (a) a film-forming binder comprising (i) the thiol functional compound and (ii) the ethylenically unsaturated compound reactive with (i).

A third aspect is directed to the coating composition of the first or second aspects, wherein the catalyst (b) is a Michael addition catalyst that catalyzes a Michael addition reaction between (i) and (ii).

A fourth aspect is directed to the coating composition of any one of the first through third aspects, wherein the odor masking agent (c) comprises at least one aromatic compound.

A fifth aspect is directed to the coating composition of the first or second aspects comprising: (a) a film-forming binder comprising (i) a thiol functional compound and (ii) an ethylenically unsaturated compound reactive with (i); (b) a Michael addition catalyst that catalyzes a Michael addition reaction between (i) and (ii); and (c) an odor masking agent comprising at least one aromatic compound and which masks an odor of at least (i) the thiol functional compound.

A sixth aspect is directed to the coating composition of any one of the first through fifth aspects, wherein a ratio of ethylenically unsaturated functional groups to thiol functional groups is within a range of from 0.5:1 to 1:0.5.

A seventh aspect is directed to the coating composition of any one of the first through sixth aspects, wherein the thiol functional compound comprises at least 2 thiol functional groups.

An eighth aspect is directed to the coating composition of any one of the first through seventh aspects, wherein the thiol functional compound comprises ester linkages.

A ninth aspect is directed to the coating composition of any one of the first through eighth aspects, wherein the ethylenically unsaturated compound comprises at least 2 ethylenically unsaturated groups.

A tenth aspect is directed to the coating composition of any one of the first through ninth aspects, wherein the ethylenically unsaturated groups are (meth)acrylate groups.

An eleventh aspect is directed to the coating composition of any one of the first through tenth aspects, wherein the catalyst is selected from bases, metals, organometallics, Lewis acids, nucleophiles, or any combination thereof.

A twelfth aspect is directed to the coating composition of the eleventh aspect, wherein the catalyst comprises an amine compound.

A thirteenth aspect is directed to the coating composition of any one of the first through twelfth aspects, wherein the odor masking agent comprises vanillin, ethylvanillin, cinnamaldehyde, hexyl cinnamaldehyde, benzaldehyde, benzyl acetate, ethyl methylphenylglycidate, methyl anthranilate, or any combination thereof.

A fourteenth aspect is directed to the coating composition of the thirteenth aspect, wherein the odor masking agent further comprises isoamyl acetate, pentyl butyrate, 4-hydroxy-2,5-dimethyl-3(2H)-furanone, allyl hexanoate, diacetyl, gamma-undecalactone, vertocitral, or any combination thereof.

A fifteenth aspect is directed to the coating composition of any one of the first through twelfth aspects, wherein the odor masking agent comprises ethyl vanillin and cinnamal.

A sixteenth aspect is directed to the coating composition of any one of the first through twelfth aspects, wherein the odor masking agent comprises benzaldehyde, furaneol, isoamyl butyrate, allyl hexanoate, and 3-methylbutyl acetate.

A seventeenth aspect is directed to the coating composition of any one of the first through sixteenth aspects, further comprising an adhesion promoter, a surface conditioner, or a combination thereof.

An eighteenth aspect is directed to the coating composition of the seventeenth aspect, wherein the coating composition further comprises the surface conditioner, and wherein the surface conditioner comprises an amino functional silane.

A nineteenth aspect is directed to the coating composition of the seventeenth aspect, wherein the coating composition further comprises the adhesion promoter, and wherein the adhesion promoter comprises an ethylenically unsaturated alkoxysilane, a thiol functional alkoxysilane, and/or an epoxy functional alkoxysilane.

A twentieth aspect is directed to the coating composition of any one of the first through nineteenth aspects, further comprising a non-aqueous or aqueous medium.

A twenty first aspect is directed to the coating composition of any one of the first through twentieth aspects, wherein the coating composition is substantially free of isocyanate functional compounds, based on the total weight of the coating composition.

A twenty second aspect is directed to a substrate at least partially coated with a coating formed from the coating composition according to any one of the first through twenty first aspects.

A twenty third aspect is directed to the substrate of the twenty second aspect, wherein the coating is formed directly over the substrate.

A twenty fourth aspect is directed to the substrate of the twenty second or twenty third aspects, wherein the substrate is pretreated with at least one component prior to application of the coating.

A twenty fifth aspect is directed to the substrate of the twenty fourth, wherein the substrate is pretreated with an adhesion promoter and/or a surface conditioner prior to application of the coating.

A twenty sixth aspect is directed to the substrate of any one of the twenty second through twenty fifth aspects, wherein the coating has a volatile organic content of less than 850 g/l.

A twenty seventh aspect is directed to a method of forming a coating over at least a portion of a substrate comprising: (i) applying a coating composition to at least a portion of a substrate, the coating composition comprising: (a) a thiol functional compound; (b) an ethylenically unsaturated compound reactive with (a); (c) a catalyst that catalyzes a reaction of (a) and (b); and (d) an odor masking agent that masks an odor of at least (a) the thiol functional compound; and (ii) curing the coating composition to form a coating.

A twenty eighth aspect is directed to the method of the twenty seventh aspect comprising: (1) applying a coating composition to at least a portion of a substrate, the coating composition comprising: (a) a film-forming binder comprising (i) a thiol functional compound and (ii) an ethylenically unsaturated compound reactive with (i); (b) a Michael addition catalyst that catalyzes a Michael addition reaction between (i) and (ii); and (c) an odor masking agent comprising at least one aromatic compound and which masks an odor of at least (i) the thiol functional compound; and (2) curing the coating composition to form a coating.

A twenty ninth aspect is directed to the method of the twenty seventh or twenty eighth aspect, wherein a ratio of ethylenically unsaturated functional groups to thiol functional groups is within a range of from 0.5:1 to 1:0.5.

A thirtieth aspect is directed to the method of any one of the twenty seventh through twenty ninth aspects, wherein the component (i), (ii), (b) and (c) are defined as specified in any one of the third, fourth, and seventh through sixteenth aspects.

A thirty first aspect is directed to the method of any one of the twenty seventh through thirtieth aspects, wherein the coating is formed from a single application of the coating composition, and the coating comprises a dry film thickness of at least 100 microns.

A thirty second aspect is directed to the method of any one of the twenty seventh through thirty first aspects, wherein the coating is applied directly over the substrate.

A thirty third aspect is directed to the method of any one of the twenty seventh through thirty second aspects, further comprising treating the substrate with an adhesion promoter and/or a surface conditioner prior to applying the coating composition.

A thirty fourth aspect is directed to the method of any one of the twenty seventh through thirty third aspects, further comprising mixing the thiol functional compound and the odor masking agent in a first liquid medium, mixing the ethylenically unsaturated compound in a second liquid medium, and mixing the catalyst in a third liquid medium, and then mixing the first, second, and third liquid mediums to form the coating composition prior to step (1).

The following examples are presented to demonstrate the general principles of the invention. The invention should not be considered as limited to the specific examples presented. All parts and percentages in the examples are by weight unless otherwise indicated.

### Example 1

### Preparation of a Surface Conditioner Composition

Two surface conditioner solutions were prepared from the components listed in Table 1.

TABLE 1

| | Example 1 | Example 2 |
|---|---|---|
| | Weight | Weight |
| Component | (grams) | (grams) |
| Butyl acetate | 95 | 0 |
| Water | 0 | 70 |
| SILQUEST ® A1100 ¹ | 5 | 0 |
| Dynasylan HYDROSIL 2776 ² | 0 | 30 |

¹ Aminopropyltriethoxysilane, commercially available from Momentive Performance Materials.
² Diaminofunctional oligomeric siloxane, commercially available from Evonik Industries.

The surface conditioner solutions were prepared by mixing the components listed in Table 1 with a cowles blade mixer for 15 minutes to form homogeneous solutions.

### Examples 3-5

### Preparation of Primer Compositions

Three primer compositions were prepared from the components listed in Table 2.

TABLE 2

| | Example 3 | Example 4 | Example 5 |
|---|---|---|---|
| | Weight | Weight | Weight |
| Component | (grams) | (grams) | (grams) |
| Setalux ® 1151 XX-51³ | 20 | 0 | 0 |
| Setalux ® 1910 BA-75 ⁴ | 10 | 0 | 0 |
| Sartomer ® SR355 ⁵ | 0 | 30 | 30 |
| Disperbyk ® 161 ⁶ | 0.4 | 0.4 | 0.4 |
| BYK ®-323 ⁷ | 0.4 | 0.4 | 0.4 |
| ANTI-TERRA ® U-1008 ⁸ | 0.5 | 0.5 | 0.5 |
| Dynasylan ® VTEO ⁹ | 0 | 0 | 0.5 |
| Bentonite | 1 | 1 | 1 |
| Xylene | 11.5 | 8.5 | 8.0 |
| Butyl acetate | 7 | 0 | 0 |
| Methyl isobutyl ketone | 2 | 0 | 0 |
| Barium sulfate | 8.0 | 10 | 10 |
| Kaolin | 8.0 | 10 | 10 |
| Talc | 9.4 | 12 | 12 |
| Dolomite | 5.6 | 7 | 7 |
| Zinc phosphate | 3.2 | 4 | 4 |
| Titanium dioxide | 12.8 | 16 | 16 |
| Carbon black | 0.2 | 0.2 | 0.2 |

³ Acrylic polyol, commercially available from Allnex.
⁴ Acrylic polyol, commercially available from Allnex.
⁵ Di-trimethylolpropane tetraacrylate, commercially available from Sartomer.
⁶ Wetting and dispersing additive, commercially available from Byk.
⁷ Aralkyl modified polymethylalkylsiloxane surface additive, commercially available from Byk.
⁸ Wetting and dispersing additive, commercially available from Byk.
⁹ Adhesion Promoter, vinyltriethoxysilane, commercially available from Evonik Industries.

Each primer composition was prepared by mixing the components listed in Table 2 with a cowles blade mixer. The mixed compositions were then passed through a beadmill charged with titania spheres to reach a grindometry of less than 25 microns.

### Examples 6-10

### Preparation of Hardener Compositions

Five hardener compositions were prepared from the components listed in Table 3.

TABLE 3

| | Example | Example | Example | Example | Example |
|---|---|---|---|---|---|
| | 6 | 7 | 8 | 9 | 10 |
| | Weight | Weight | Weight | Weight | Weight |
| Component | (grams) | (grams) | (grams) | (grams) | (grams) |
| Butyl acetate | 9.9 | 4 | 2 | 3 | 4 |
| Desmodur ® N3390 | 70 | 0 | 0 | 0 | 0 |
| BA/SN ¹⁰ | | | | | |
| Desmodur ® z4470 ¹¹ | 10 | 0 | 0 | 0 | 0 |
| THIOCURE TMPMP ¹² | 0 | 95 | 95 | 95 | 95 |
| Triethylamine | 0 | 1 | 1 | 0 | 0 |
| MASQUODOR VN ¹³ | 0 | 0 | 2 | 2 | 0 |
| MASQUODOR FR ¹⁴ | 0 | 0 | 0 | 0 | 1 |
| Dibutyltin diacetate | 0.05 | 0 | 0 | 0 | 0 |
| Dibutyltin dilaurate | 0.05 | 0 | 0 | 0 | 0 |

¹⁰ Aliphatic polyisocyanate (HDI trimer), commercially available from Convestro.
¹¹ Aliphatic polyisocyanate (IPDI trimer), commercially available from Convestro.
¹² Trimethylolpropane Tris(3-mercaptopropionate), commercially available from Evans Chemetics LP.
¹³ Odor masking agent comprising ethyl vanillin and cinnamal, commercially available from Synthron.
¹⁴ Odor masking agent comprising benzaldehyde, furaneol, isoamyl butyrate, allyl hexanoate, and 3-methylbutylacetate, commercially available from Synthron.

The components listed in Table 3 were dispersed and mixed with a cowles blade mixer to form a homogeneous mixer.

### Examples 11-13

### Preparation of Solvent Compositions

Three solvent thinner compositions were prepared from the components listed in Table 4.

TABLE 4

| | Example 11 | Example 12 | Example 13 |
|---|---|---|---|
| | Weight | Weight | Weight |
| Component | (grams) | (grams) | (grams) |
| Butyl Acetate | 50 | 49.5 | 44.5 |
| Methoxy propyl acetate | 30 | 30 | 25 |
| Ethyl ethoxy propionate | 20 | 20 | 15 |
| Triethylamine | 0 | 0.5 | 0.5 |
| Dynasylan ® MEMO ¹⁵ | 0 | 0 | 15 |

¹⁵ 3-methacryloxypropyltrimethoxysilane, commercially available from Evonik.

Each solvent composition was prepared by mixing the components listed in Table 4 with a cowles blade mixer.

### Examples 14-17

### Preparation of Curable Coating Compositions and Application of Coatings

Part A: Four curable coating compositions were first prepared by combining and mixing the separate compositions listed in Table 5.

TABLE 5

| | Compa- | Compa- | | |
|---|---|---|---|---|
| | rative | rative | | |
| | Example | Example | Example | Example |
| | 14 | 15 | 16 | 17 |
| | Weight | Weight | Weight | Weight |
| Component | (grams) | (grams) | (grams) | (grams) |
| Primer composition of | 100 | 0 | 0 | 0 |
| Example 3 | | | | |
| Primer composition of | 0 | 100 | 100 | 100 |
| Example 4 | | | | |
| Hardener composition of | 10 | 0 | 0 | 0 |
| Example 6 | | | | |
| Hardener composition of | 0 | 25 | 0 | 0 |
| Example 7 | | | | |
| Hardener composition of | 0 | 0 | 25 | 0 |
| Example 8 | | | | |
| Hardener composition of | 0 | 0 | 0 | 25 |
| Example 9 | | | | |
| Solvent composition of | 10 | 0 | 0 | 0 |
| Example 11 | | | | |
| Solvent composition of | 0 | 10 | 10 | 10 |
| Example 12 | | | | |

Part B: The curable coating compositions listed in part A were applied to bare steel panels with a SATA jet 100BSRP HVLP gun with a 1.6 to 1.9 tip. The curable coating compositions of Examples 15-17 were applied to panels that were first treated with the surface conditioner composition of Example 1.

The coatings formed after application of the curable coating compositions of Examples 14-17 were tested for various properties. The test results and coating application parameters are listed in Table 6.

TABLE 6

| | Compa- | Compa- | | |
|---|---|---|---|---|
| | rative | rative | | |
| | Exam- | Exam- | Exam- | Exam- |
| Component | ple 14 | ple 15 | ple 16 | ple 17 |
| Thickness | Normal | Very High | Very High | Very High |
| | (from 60 | (from 60 | (from 60 | (from 60 |
| | to 140 | to 200 | to 200 | to 200 |
| | microns) | microns) | microns) | microns) |
| Smell | Strong | Strong | Pleasant | Pleasant |
| | smell | sulfur | smell | smell |
| | | smell | | |
| Smell through | Constant | Constant | Not | Constant |
| product shelf life | | | constant | |
| | | | (through | |
| | | | time | |
| | | | sulfur | |
| | | | smell | |
| | | | reappears) | |
| Flash off between | 5′-7′ | Not needed | Not needed | Not needed |
| coats | | | | |
| Flash off before cure | 5′-7′ | Not needed | Not needed | Not needed |
| Number of coating | 2-3 | One Visit | One Visit | One Visit |
| applications required | | application | application | application |
| Sag Resistance | Good | Very Good | Very Good | Very Good |
| Sanding | Good | Very Good | Very Good | Very Good |
| Ringing/Mapping | None | None | None | None |
| Curing process | Slow | Very Fast | Very Fast | Fast |
| Curing Process and | Constant | Constant | Not | Constant |
| Adhesion of film | | | constant | |
| during | | | (through | |
| product shelf life | | | time | |
| | | | curing | |
| | | | speed | |
| | | | increase) | |
| Final Appearance | Acceptable | Good | Good | Good |

Thickness was measured through BYKO-TEST 8500. Smell testing was perceived after coating application cycles and accelerated heat aging test conducted at 5° C., room temperature, 40° C. and 60° C. for three months. All remaining measured parameters were measured through visual parameters taken in comparison with Comparative Example 14.

As shown in Table 6, the coatings of the present invention were formed with a single application of the coating composition at a high dry film thickness without any flashing while also providing very good or good sag resistance, sanding properties, fast curing process, and final appearance and no ringing or mapping. The coating compositions of Examples 16 and 17 further masked the unpleasant smell of the thiol functional compound as compared to Comparative Examples 14 and 15.

As further shown in Table 6, the odor masking agent of Example 17 masked the unpleasant smell of the thiol functional compound continuously throughout the storage shelf life by storing the catalyst separately from the thiol functional compound and odor masking agent. It is appreciated that the catalyst and thiol functional compound of Example 16 were stored together.

### Examples 18-22

### Preparation of Curable Coating Compositions and Application of Coatings

Part A: Five curable coating compositions were first prepared by combining and mixing the separate compositions listed in Table 7.

TABLE 7

| | Example | Example | Example | Example | Example |
|---|---|---|---|---|---|
| | 18 | 19 | 20 | 21 | 22 |
| | Weight | Weight | Weight | Weight | Weight |
| Component | (grams) | (grams) | (grams) | (grams) | (grams) |
| Primer | 100 | 100 | 100 | 0 | 100 |
| composition of | | | | | |
| Example 4 | | | | | |
| Primer | 0 | 0 | 0 | 100 | 0 |
| composition of | | | | | |
| Example 5 | | | | | |
| Hardener | 25 | 0 | 0 | 0 | 0 |
| composition of | | | | | |
| Example 8 | | | | | |
| Hardener | 0 | 25 | 0 | 0 | 0 |
| composition of | | | | | |
| Example 9 | | | | | |
| Hardener | 0 | 0 | 25 | 25 | 25 |
| composition of | | | | | |
| Example 10 | | | | | |
| Solvent | 0 | 0 | 0 | 10 | 0 |
| composition of | | | | | |
| Example 12 | | | | | |
| Solvent | 10 | 10 | 10 | 0 | 10 |
| composition of | | | | | |
| Example 13 | | | | | |

Part B: The curable coating compositions of Examples 18-21 listed in part A were applied to bare steel panels with a SATA jet 100BSRP HVLP gun with a 1.6 to 2.0 tip.

The coatings formed after application of the curable coating compositions of Examples 18-21 were tested for various properties. The test results and coating application parameters are listed in Table 8.

TABLE 8

| | | Exam- | Exam- | Exam- |
|---|---|---|---|---|
| Component | Example 18 | ple 19 | ple 20 | ple 21 |
| Thickness | Very High | Very High | Very High | Very High |
| | (from 60 | (from 60 | (from 60 | (from 60 |
| | to 300 | to 300 | to 300 | to 300 |
| | microns) | microns) | microns) | microns) |
| Smell | Pleasant | Pleasant | Pleasant | Pleasant |
| | smell | smell | smell | smell |
| Smell through | Not constant | Constant | Constant | Constant |
| product shelf | (through time | | | |
| life | sulfur smell | | | |
| | reappears) | | | |
| Flash off | Not needed | Not needed | Not | Not |
| between coats | | | needed | needed |
| Flash off | Not needed | Not needed | Not | Not |
| before cure | | | needed | needed |
| Number of | One Visit | One Visit | One Visit | One Visit |
| coating | applications | application | appli- | application |
| required | | | cation | |
| Sag Resistance | Very Good | Very Good | Very Good | Very Good |
| Sanding | Very Good | Very Good | Very Good | Very Good |
| Ringing/Mapping | None | None | None | None |
| Curing process | Fast | Normal | Normal | Normal |
| Curing Process | Not constant | Constant | Constant | Not |
| and Adhesion | (through time | | | constant |
| of film during | curing speed | | | (through |
| product shelf | increase) | | | time |
| life | | | | curing |
| | | | | speed |
| | | | | increase |
| | | | | and |
| | | | | adhesion |
| | | | | decrease) |
| Final | Good | Good | Good | Good |
| Appearance | | | | |

Thickness was measured through BYKO-TEST 8500. Smell testing was perceived after coating application cycles and accelerated heat aging test conducted at 5° C., room temperature, 40° C. and 60° C. for three months. All remaining measured parameters were measured through visual parameters taken in comparison with Comparative Example 14.

As shown in Table 8, the coatings of Examples 18-21 were formed with a single application of the coating composition at a high dry film thickness without any flashing while also providing very good or good sag resistance, sanding properties, fast curing process, and final appearance and no ringing or mapping. The coating compositions also masked the unpleasant smell of the thiol functional compound.

As further shown in Table 8, the odor masking agent of Examples 19-21 masked the unpleasant smell of the thiol functional compound continuously throughout the storage shelf life by storing the catalyst separately from the thiol functional compound and odor masking agent. It is appreciated that the catalyst and thiol functional compound of Example 18 were stored together.

Part C: The curable coating composition of Example 22 listed in part A was applied to bare steel panels with a SATA jet 100BSRP HVLP gun with a 1.6 to 2.0 tip. Prior to application of the coating compositions, some of the bare steel panels were first treated with a surface conditioner.

The coatings formed after application of the curable coating compositions of Example 22 were tested for various properties. The test results and coating application parameters are listed in Table 9.

TABLE 9

| Component | Example 22a | Example 22b | Example 22c |
|---|---|---|---|
| Surface conditioner | Example 1 | Example 2 | None |
| Thickness | Very High | Very High | Very High |
| | (from 60 to 300 | (from 60 to 300 | (from 60 to 300 |
| | microns) | microns) | microns) |
| Smell | Pleasant smell | Pleasant smell | Pleasant smell |
| Smell through product | Constant | Constant | Constant |
| shelf life | | | |
| Flash off between coats | Not needed | Not needed | Not needed |
| Flash off before cure | Not needed | Not needed | Not needed |
| Number of coating | One Visit appli- | One Visit | One Visit |
| applications required | cation | application | application |
| Sag Resistance | Very Good | Very Good | Very Good |
| Sanding | Very Good | Very Good | Very Good |
| Ringing/Mapping | None | None | None |
| Curing Process | Fast | Very Fast | Normal |
| Curing Process and | Constant | Constant | Constant |
| Adhesion of film | | | |
| during product shelf | | | |
| life | | | |
| Final Appearance | Good | Good | Good |

Thickness was measured through BYKO-TEST 8500. Smell testing was perceived after coating application cycles and accelerated heat aging test conducted at 5° C., room temperature, 40° C. and 60° C. for three months. All remaining measured parameters were measured through visual parameters taken in comparison with Comparative Example 14.

As shown in Table 9, the coatings of the present invention of Examples 22 were formed with a single application of the coating composition at a high dry film thickness without any flashing while also providing very good or good sag resistance, sanding properties, fast curing process, and final appearance and no ringing or mapping. The coating compositions further masked the unpleasant smell of the thiol functional compound.

As further shown in Table 9, the panels treated with the surface conditioners of Examples 22a and 22b improved the curing speed of the coating compositions.

Whereas particular embodiments of this invention have been described above for purposes of illustration, it will be evident to those skilled in the art that numerous variations of the details of the present invention may be made without departing from the invention as defined in the appended claims.

The invention claimed is:

1. A coating composition comprising:
(a) (i) a thiol functional compound and (ii) an ethylenically unsaturated compound reactive with (i);
(b) a catalyst that catalyzes a reaction of (i) and (ii); and
(c) an odor masking agent that masks an odor of at least (i) the thiol functional compound.

2. The coating composition of claim 1, wherein the coating composition comprises a film-forming binder comprising (i) the thiol functional compound and (ii) the ethylenically unsaturated compound reactive with (i).

3. The coating composition of claim 1, wherein a ratio of ethylenically unsaturated functional groups to thiol functional groups is within a range of from 0.5:1 to 1:0.5.

4. The coating composition of claim 1, wherein the thiol functional compound comprises at least 2 thiol functional groups.

5. The coating composition of claim 4, wherein the thiol functional compound comprises ester linkages.

6. The coating composition of claim 1, wherein the ethylenically unsaturated compound comprises at least 2 ethylenically unsaturated groups.

7. The coating composition of claim 6, wherein the ethylenically unsaturated groups are (meth)acrylate groups.

8. The coating composition of claim 1, wherein the catalyst is a Michael addition catalyst that catalyzes a Michael addition reaction between (i) and (ii).

9. The coating composition of claim 1, wherein the catalyst comprises an amine compound.

10. The coating composition of claim 1, further comprising an adhesion promoter, a surface conditioner, or a combination thereof.

11. The coating composition of claim 10, wherein the coating composition further comprises the surface conditioner, and wherein the surface conditioner comprises a halogen functional silane and/or an amino functional silane.

12. The coating composition of claim 10, wherein the coating composition further comprises the adhesion promoter, and wherein the adhesion promoter comprises an ethylenically unsaturated alkoxysilane, a thiol functional alkoxysilane, and/or an epoxy functional alkoxysilane.

13. The coating composition of claim 1, wherein the odor masking agent comprises at least one aromatic compound and which masks an odor of at least (i) the thiol functional compound.

14. The coating composition of claim 1, further comprising a non-aqueous or aqueous solvent.

15. The coating composition of claim 1, wherein the coating composition is substantially free of isocyanate functional compounds, based on the total weight of the coating composition.

16. A substrate at least partially coated with a coating formed from the coating composition according to claim 1.

17. The substrate of claim 16, wherein the coating is formed directly over the substrate.

18. The substrate of claim 16, wherein the substrate is pretreated with at least one component prior to application of the coating.

19. The substrate of claim 16, wherein the coating has a volatile organic content of less than 850 g/l.

20. A method of forming a coating over at least a portion of a substrate comprising:
(1) applying a coating composition to at least a portion of a substrate, the coating composition comprising:
(a) (i) a thiol functional compound and (ii) an ethylenically unsaturated compound reactive with (i);
(b) a catalyst that catalyzes a reaction between (i) and (ii); and
(c) an odor masking agent that masks an odor of at least (i) the thiol functional compound; and
(2) curing the coating composition to form a coating.

21. The method of claim 20, wherein the coating composition comprises a film-forming binder comprising (i) the thiol functional compound and (ii) the ethylenically unsaturated compound reactive with (i).

22. The method of claim 20, wherein the catalyst is a Michael addition catalyst that catalyzes a Michael addition reaction between (i) and (ii), and wherein the odor masking agent comprises at least one aromatic compound and which masks an odor of at least (i) the thiol functional compound.

23. The method of claim 20, wherein the coating is formed from a single application of the coating composition, and the coating comprises a dry film thickness of at least 100 microns.

24. The method of claim 20, wherein the coating is applied directly over the substrate.

25. The method of claim 20, further comprising treating the substrate with an adhesion promoter and/or a surface conditioner prior to applying the coating composition.

26. The method of claim 20, further comprising mixing the thiol functional compound and the odor masking agent in a first liquid medium, mixing the ethylenically unsaturated compound in a second liquid medium, and mixing the catalyst in a third liquid medium, and then mixing the first, second, and third liquid mediums to form the coating composition prior to step (i).
